(19) United States
(12) Patent Application Publication
(10) Pub. No.: US 2024/0218577 A1
(43) Pub. Date: Jul. 4, 2024

(54) BIOBASED BINDER COMPOSITIONS FOR AIRLAID NONWOVEN MATERIALS

(71) Applicant: ORGANOCLICK AB, Täby (SE)

(72) Inventors: Maria WENNMAN, Täby (SE); Mårten HELLBERG, Enebyberg (SE); Saina KISHANI, Solna (SE)

(73) Assignee: ORGANOCLICK AB, Täby (SE)

(21) Appl. No.: 18/558,363

(22) PCT Filed: May 4, 2022
(86) PCT No.: PCT/SE2022/050429

§ 371 Date: Oct. 31, 2023

(30) Foreign Application Priority Data
May 4, 2021 (SE) 2150568-0

(51) Int. Cl. D04H 1/64; C09D 7/63; C09D 101/28; C09D 103/04; C09D 105/00; D04H 1/26; D04H 1/425; D04H 1/587; D04H 1/732; D06M 101/06; D21H 19/12; D21H 23/32

(52) U.S. Cl. CPC D04H 1/64; C09D 7/63; C09D 101/28; C09D 103/04; C09D 105/00; D04H 1/26; D04H 1/425; D04H 1/587; D04H 1/732; D21H 19/12; D21H 23/32; D06M 2101/06; D10B 2401/063; D10B 2401/12

(57) ABSTRACT

The present invention relates to biobased binder compositions which are environmentally benign, renewable, compostable and/or biodegradable. The biobased compositions comprise chitosan, an acid and a plasticizer. By treating an airlaid nonwoven material with a biobased binder according to the present invention, it is possible to provide an airlaid nonwoven material exhibiting higher elongation, i.e., elongation at break, and strength compared to an airlaid nonwoven material treated with previously available biobased binders.

### TECHNICAL FIELD

The present invention relates to biobased binder compositions which are environmentally benign, renewable, compostable and/or biodegradable. The biobased compositions comprise chitosan, an acid and a plasticizer. The invention further relates to a method of treating an airlaid nonwoven with a biobased binder composition according to the present invention.

The compositions according to the present invention are suitable as a binder for airlaid nonwoven materials. The treatment of airlaid nonwoven materials with a binder composition according to the present invention, provides airlaid nonwoven materials which exhibit higher elongation, i.e. elongation at break, and strength compared to airlaid nonwoven materials treated with previously available biobased binders.

### BACKGROUND ART

Airlaid nonwovens are traditionally used in the manufacturing of disposable diapers, feminine hygiene articles, industrial wipes, wet wipes, napkins, table cloths and other products requiring high softness. They are usually characterized by their bulkiness, softness and high water absorption.

In the airlaid process, a continuous web of fibres is formed using air as medium. Generally, fibres are dispersed in an air stream and deposited on for instance a moving wire. The resulting deposit is then compressed, for instance by pressure or vacuum. However, the material is at this stage totally unbonded since it cannot build up an internal strength as for example wetlaid nonwoven or paper can due to the hydrogen bonds formed in a wet process.

In order to achieve bonding or other mechanical improvements in airlaid nonwovens, a binder is usually added and may be introduced at different stages in the manufacturing process depending on the type of binder used. Traditionally, both liquid binders, slurries, suspensions, foams or powder binders have been used. The most common bonding technique is the addition of a liquid binder, such as latex, added to the sides of the formed web and subsequentially cured. Another bonding alternative is thermal bonding, where synthetic fibres are added to the fiber air-dispersion and the resulting nonwoven material is heated resulting in bonding between the synthetic fibres.

Elongation is a key requirement for airlaid nonwoven materials. If too stiff, i.e. not flexible with a soft hand feel, the airlaid nonwoven will be perceived as unpleasant to the user. Moreover, if the airlaid nonwoven material is not sufficiently strong and flexible, the material might break apart when used. To combine strength, soft hand feel and flexibility is thus of crucial importance when developing airlaid nonwovens. In addition, the production and processing of the material require high elongation and strength.

In an attempt to reduce the usage of synthetic binders, i.e. plastic binders, attention has been drawn to biobased polymers that can substitute the synthetic polymers used for airlaid nonwovens. Nevertheless, none of the alternatives so far can achieve an airlaid nonwoven article with sufficiently high elongation which is a crucial parameter for such a product.

Previous attempts have been made to reduce or eliminate the usage of synthetic binders in nonwovens, such as in WO2020068151A1. However, the article disclosed in WO2020068151 A1 still comprises synthetic fibres and/or wet strength agents.

The use of chitosan as a binder component in nonwoven materials has been examined before, such as in WO2012015863 A1. However, as clearly stated in WO2012015863 A1, chitosan as the sole binder is not able to provide sufficiently good levels of mechanical properties such as for instance tensile strength. Therefore, a synthetic component, i.e. vinyl acetate ethylene, is provided in order to improve these properties as well as strength and elongation properties.

Bio-based polyelectrolyte complexes (PEC) have also been studied as an environmentally friendly binder alternative for materials such as fiber based materials, textiles, woven and nonwoven. PECs are association complexes formed between oppositely charged polycations and polyanions, formed due to electrostatic interaction between the oppositely charged polyions. Such a binder is for instance described in WO 2018 038671 A1. However, an airlaid nonwoven treated with a PEC binder composition will only show an elongation of around 3%, which as previously described is not sufficiently high for an airlaid nonwoven article. An elongation of around 6-9% is normally required.

There is thus still a need for a biobased binder for airlaid nonwovens, providing strength and most importantly elongation properties comparable to that of conventional synthetical binders used for airlaid nonwovens.

### SUMMARY OF INVENTION

An object of the present invention is to provide a biobased binder composition suitable as a binder for an airlaid nonwoven material.

A further object of the invention is to provide a biobased binder composition which gives sufficiently high elongation to a treated airlaid nonwoven material.

A further object of the invention is to provide a biobased binder composition that is environmentally friendly, renewable, compostable and/or biodegradable.

A further object of the invention is to provide an airlaid nonwoven which exhibits strength and sufficiently good elongation, preferably an elongation of at least 4%.

Any combination of the above objects is also possible.

In one general aspect, the invention relates to an aqueous biobased binder composition for an airlaid nonwoven material, said composition comprising an acid, a plasticizer and a cationic polyelectrolyte comprising chitosan, and wherein;
the chitosan has a degree of deacetylation of 66-100%, and wherein the composition comprises 0.005-20 wt % of chitosan,
the acid in the aqueous binder composition is a Brønsted acid and/or a Lewis acid, wherein the Brønsted acid is selected from any organic and/or inorganic acids, wherein the Lewis acid is selected from any cationic mono- or multivalent atom, and wherein the aqueous binder composition comprises preferably 0.01-30 wt % of acid,
the aqueous binder composition comprises at least 15 wt % of plasticizer, preferably at least 20 wt % of plasticizer,
the pH of the aqueous binder composition is less than 7, and wherein the cationic polyelectrolyte is not in a complex with an anionic polyelectrolyte.

By an aqueous biobased binder composition according to the present invention, a binder for an airlaid nonwoven material comprising a high amount, or completely made of, renewable materials is achieved. Furthermore, it has surprisingly been found that an aqueous binder composition according to the present invention is able to better act as a binder in an airlaid nonwoven material, thus resulting in a material exhibiting both sufficiently high strength and elongation compared to conventional synthetic binders used by the industry. Chitosan, compared to other cationic polyelectrolytes, imparts higher tensile index to a material treated with the binder composition. Preferably, the binder composition comprises at least 50 wt % of biobased, i.e. of natural origin, components, more preferably at least 60 wt %, more preferably at least 70 wt %, even more preferably at least 80 wt % and most preferably at least 90 wt %.

It has been found that in a binder composition according to the present invention, a cationic polyelectrolyte comprising chitosan without the presence of an anionic polyelectrolyte counter ion in the composition is able to better spread within the airlaid nonwoven material, thus resulting in a more homogenous distribution. Without being bound by theory, it is believed that the lack of an electrostatic interaction between the cationic polyelectrolyte and an anionic polyelectrolyte, results in a cationic polyelectrolyte in a more expanded shape. If the cationic polyelectrolyte was to interact with an anionic counter component, the resulting polyelectrolyte complex would exhibit a more coiled structure. By achieving a more expanded shape, it is believed that the cationic polyelectrolyte is able to better spread within the airlaid nonwoven structure. This results in a stronger and more flexible airlaid nonwoven material, compared to if a PEC binder composition was used, as the chitosan will act as a binding component linking with itself as well as with fibres within the airlaid nonwoven material. The synergistic effect between the cationic polyelectrolyte comprising chitosan and the plasticizer results in a composition suitable as a binder for airlaid nonwovens that is able to achieve both strength as well as elongation of a treated material comparable to conventional synthetic binders used.

It is important that the pH is below 7 in the aqueous binder composition, as an acidic environment is needed for the chitosan to be in its cationic form. Preferably, the pH of the composition is lower than 6.5, preferably the pH of the composition is between 1.8-5.

In one aspect, the aqueous binder composition may further comprise a solvent selected from distilled water, tap water and deionized water.

In one aspect, the aqueous binder composition comprises chitosan as cationic polyelectrolyte, lactic acid as acid, and at least one of sorbitol, hydrolysed starch, xylitol and maltitol as plasticizer. Preferably, the plasticizer comprises hydrolysed starch.

The amount of each of the components of the aqueous biobased binder composition depends on the intended use of the composition and the required properties necessary for that use, such as for instance strength, softness and/or elongation.

In one aspect, the aqueous binder composition may further comprise at least 22 wt % of plasticizer, preferably at least 24 wt %, even more preferably at least 25 wt %. In one aspect, the composition comprises 20-30 wt % of plasticizer.

In one aspect, the cationic polyelectrolyte in the aqueous binder composition consists of chitosan.

In one aspect, the aqueous binder composition does not contain an anionic polyelectrolyte. If a substantial amount of an anionic polyelectrolyte would be present in the composition, the cationic and anionic polyelectrolyte would form a polyelectrolyte complex (PEC), resulting in an impaired functionality of the binder composition as previously described.

In one aspect, the aqueous binder composition comprises 0.005-15 wt % of chitosan, preferably 0.005-10 wt %, and even more preferably 0.005-5 wt % of chitosan. In one aspect, the composition comprises 0.5-3 wt % of chitosan, even more preferably between 1.5-2.5 wt %. The wt % of chitosan is optimized based on the desired viscosity. Preferably, the composition comprises about 2 wt % chitosan. In one aspect, the composition comprises 2.1 wt % of chitosan.

In one aspect, the plasticizer is a polyol, preferably the polyol is selected from one or more of glycerol, mannitol, maltitol, xylitol and, sorbitol and saccharides selected from glucose, mannose, fructose, sucrose, sucralose, sucrose esters, cyclodextrin, hydrolysed starch, dextrin and similar. In one aspect, the plasticizer is preferably sorbitol.

In the context of the plasticizer, hydrolysed starch is a product from chemical or enzymatic treatment of starch from various natural sources. The hydrolysed starch can be hydrogenated and comprise a mixture of polyols, suitable brands for the present invention can be those with CAS No. 68425-17-2 and/or as No. 1259528-21-6 or the similar.

In one aspect, the acid is selected from one or more of acetic acid, acetylsalicylic acid, adipic acid, benzenesulfonic acid, camphorsulfonic acid, citric acid, citric acid monohydrate, dihydroxy fumaric acid, formic acid, glycolic acid, glyoxylic acid, hydrochloric acid, lactic acid, malic acid, malonic acid, maleic acid, mandelic acid, oxalic acid, para-toluenesulfonic acid, phtalic acid, pyruvic acid, salicylic acid, sulfuric acid, tartaric acid and succinic acid, preferably lactic acid.

In one aspect, the aqueous binder composition further comprises at least one or more of an additive selected from defoamer, foaming agent, wetting agent, coalescent agent, catalyst, surfactant, emulsifier, preservative, rheology modifiers, fillers, nonionic polymers, dye and pigment, wherein the concentration of the additive is 0-50 wt % by weight more preferably 0-30% by weight of the total weight of the composition. Said additives are selected depending on application method and expected final material properties.

The catalyst can be chosen from Lewis bases and acids, such as clays, colloidal or noncolloidal silica, dialdehydes, organic amines, organic amides, quaternary amines, metal oxides, metal sulphates, metal chlorides, urea sulphates, urea chlorides and catalysts based on silicates.

The preservative can be selected from one or more of fungicide, bactericide, pharmaceutical preservative, cosmetic preservative and food preservatives. The inclusion of a preservative helps to inhibit the growth of mold in the binder composition. Moreover, it was discovered that binder compositions without preservative become more yellow/brown than a binder composition comprising a preservative. Even if performance is the same between the more yellow and less yellow composition, the yellow colour is transferred to material and causes yellowing which is unwanted.

The filler may be selected from one or more of gum arabic, konjac glucomannan, organic fillers such as wood flour, starch soy flour, olive seed flour, cork flour, corn cobs, rice brain husks, and inorganic fillers such as calcium carbonate, glass fibre, kaolin, talc and mice and other fillers known to the skilled person.

In one aspect, the aqueous binder composition comprises 1-2.5 wt % of chitosan, 20-40 wt % of plasticizer, 0.05-3 wt % of acid and optionally 0.05-10 wt % of at least one or more of an additive selected from defoamer, foaming agent, wetting agent, coalescent agent, catalyst, surfactant, emulsifier, conservative, cross-linker, rheology modifiers, fillers, nonionic polymers, dye and pigment.

In another general aspect, the present invention is directed to a method of treating an airlaid nonwoven material with a biobased binder composition, wherein the method comprises the steps of:
a) providing a binder composition comprising an acid, a plasticizer and a cationic polyelectrolyte comprising chitosan, wherein the chitosan has a degree of deacetylation of 66-100%, the acid in the binder composition is a Brønsted acid and/or a Lewis acid, wherein the Brønsted acid is selected from any organic and/or inorganic acids, wherein the Lewis acid is selected from any cationic mono- or multivalent atom;
b) optionally, diluting the binder composition to an aqueous binder composition according to any one of the previous aspects;
c) applying the composition of step a) or b) to an airlaid nonwoven by applying the binder composition on a formed airlaid nonwoven web;
d) optionally curing the treated airlaid nonwoven material, preferably wherein the curing is performed at 20 to 200 degrees C.

In one aspect, the binder composition provided in step a) is an aqueous binder composition according to any of the previous aspects. In one aspect, the aqueous binder composition provided in step a) comprises an acid, a plasticizer and a cationic polyelectrolyte comprising chitosan, and wherein;
the chitosan has a degree of deacetylation of 66-100% and wherein the aqueous binder composition comprises 0.005-20 wt % of chitosan;
the acid in the aqueous binder composition is a Brønsted acid and/or a Lewis acid, wherein the Brønsted acid is selected from any organic and/or inorganic acids, wherein the Lewis acid is selected from any cationic mono- or multivalent atom, and wherein the aqueous binder composition comprises preferably 0.01-30 wt % of acid;
the aqueous binder composition comprises at least 15 wt % of plasticizer, preferably at least 20 wt % of plasticizer;
the pH of the binder composition is less than 7,
   and wherein the cationic polyelectrolyte is not in a complex with an anionic polyelectrolyte.

In one aspect of the invention, the binder composition in step b) is diluted to an aqueous binder composition comprising 1-2.5 wt % of chitosan, 20-40 wt % of plasticizer, 0.05-3 wt % of acid and optionally 0.05-10 wt % of at least one or more of an additive selected from defoamer, foaming agent, wetting agent, coalescent agent, catalyst, surfactant, emulsifier, conservative, cross-linker, rheology modifiers, fillers, nonionic polymers, dye and pigment.

By using a method according to the present invention, an airlaid nonwoven material is achieved exhibiting improved strength and elongation properties comparable to airlaid nonwovens bonded with conventional binders. This enables the substitution of conventional binders with a more environmentally friendly alternative, without impairing the mechanical properties of the airlaid nonwoven material.

In one aspect, the method results in higher elongation of the treated airlaid nonwoven, preferably the method results in an elongation of at least 4%, preferably at least 6%. As used herein, elongation means the total elongation at break measured according to standard Edana 20.2-89.

In one aspect, the curing is performed at 20 to 200 degrees C. Preferably, the curing is performed above 135 degrees C., preferably above 150 degrees C.

The binder composition can be applied by for instance spraying the binder composition on the airlaid nonwoven material, or by coating the binder composition on the airlaid nonwoven material, or by impregnating the binder composition on the airlaid nonwoven material.

In another general aspect, the present invention is directed to an airlaid nonwoven material treated with a binder composition as defined in any one of the previous aspects. In one aspect, the treated airlaid nonwoven material is treated with a binder composition as defined in any one of the previous aspects wherein the composition acts as a binder.

In one aspect, the airlaid nonwoven material exhibits an elongation of at least 4% after the treatment with an aqueous binder composition as defined in any one of the previous aspects. Preferably, the elongation is at least 6%. The elongation is measured according to Edana 20.2-89.

In another general aspect, the present invention is directed to use of an aqueous binder composition according to any one of the previous aspects for treating an airlaid nonwoven material. The use of the aqueous composition is preferably for providing higher elongation, i.e. elongation at break, and strength compared to airlaid nonwoven materials treated with previously available biobased binders.

### DESCRIPTION OF EMBODIMENTS

In the following, a detailed description of the present invention is provided.

As used herein, “wt %” refers to weight percent of the ingredient, or ingredients, referred to of the total weight of the compound or composition referred to.

As used herein, “about” refers to a measurable value, such as an amount, meant to encompass variations of +/−5% or less, even more preferably +/−1% or less, and still more preferably +/−0.1% or less of and from the specified value, in so far the skilled person understands that such variations are appropriate to perform in the disclosed invention. However, it is to be understood that the value to which “about” refers to is itself also specifically disclosed.

As used herein, an airlaid nonwoven material is a nonwoven material produced by an airlaid (drylaid) process. The airlaid nonwoven can be produced by natural fibres such as wood fibres (e.g. pulp), fluff pulp, or man-bade biobased fibres such as viscose, lyocell, PLA etc. A small or substantial amount of synthetic fibres such as PES, PET, PP etc. can also be present in the airlaid nonwoven material. The airlaid nonwoven material can be used in, but are not limited to, applications such as hygiene applications such as baby diapers, feminine hygiene products, and adultery care products; tabletop products such as napkins or tablecloths; filter materials; automotive nonwovens; tea bags and coffee filters; medical nonwovens used for face masks, surgical gowns and hair covers; food packaging materials; wipes and wet wipes; geotextiles.

Below, all experimental chemicals, equipment and methods used in examples 1-5 are described.

### Chemicals

All chemicals used within the present invention are described in Table 1.

TABLE 1
Chemicals used for the present
invention and their commercial names

| Chemicals | Description |
|---|---|
| Citric acid mono hydrate | Powder |
| Carboxymethyl cellulose | Powder |
| (CMC) | |
| Lactic acid | 80% liquid |
| Chitosan | Powder |
| Chitosan 1 (85% DA) | Powder |
| Chitosan 2 (90% DA) | Powder |
| Chitosan 3 (94% DA) | Powder |
| Chitosan 4 (94% DA) | Powder |
| Acticide AB6 (biocide) | Suspension |
| Hydrogenated hydrolysed | 70% syrup |
| starch | |
| Sorbitol | Powder |
| Xylitol | Powder |
| Maltitol | Powder |

### Equipment

All equipment used in the patent are listed below.
Homogenization of formulations was done using IKA T25 digital Ultra-Turrax.
Coating of nonwoven was performed with Wichelhaus WI-MU 505 A horizontal padder.
Drying of treated nonwoven were done in oven from Termaks with a needle frame.
Tensile tests were conducted using Testometric M250-2.5 AT (machine capacity 2.5 kN) together with Wintest Analysis software.

### Material

Two nonwoven substrates were used for the present experiments. They are described further in Table 2. A small amount of EVA is present so to stabilize the material for handling and shipping.

TABLE 2
Nonwoven material used in the experimental section

| Name in the | | Gsm (g/m2) |
|---|---|---|
| experimental section | Description | untreated |
| Wetlaid nonwoven | Wetlaid nonwoven based | 60 |
| | on 100% cellulose | |
| Airlaid nonwoven | Airlaid nonwoven based | 70 |
| | on 100% fluff pulp with | |
| | one side bonded with | |
| | EVA (ethylene vinyl | |
| | acetate) | |

### Methods

In the following section, all methods referred to in the examples are described.
Method A: Coating nonwovens with the horizontal padder using pressure 0.1 MPa and speed 11.6 together with drying with a stenter frame in 150° C. for three minutes. Three to five nonwoven sheets for each test point were treated. Two to three sample specimens at each test point were cut out and tested.
Method B: Tensile testing of dry nonwoven was performed using Testometric M250-2.5 AT (pretension: 0.01 N, sample length: 200 mm, width: 50 mm, speed: 100 mm/min, Load cell 1: 250 kgf) after having test specimens at least 20 h in 23° C. and 50% RH.
Method C: Tensile testing of wet nonwoven was performed using Testometric M250-2.5 AT (pretension: 0.01 N, sample length: 200 mm, width: 50 mm, speed: 100 mm/min, Load cell 1: 250 kgf) after having test specimens at least 20 h in 23° C. and 50% RH and then soaked in water for 15 see in a Finch cup.

### Experiments

### Experiment 1: Design of Basic Concept of PEC Binders for Evaluation of Mechanical Properties

Two initial concept formulations with a polycation, a polyanion, an acid and a plasticizer were created to evaluate mechanical properties on nonwoven substrates. The two concept formulation included either citric acid (Table 3) or lactic acid (Table 4). Within the concept formulations, different plasticizers were tried.

TABLE 3
Citric acid formulations

| RAW | Binder | Binder | Binder |
|---|---|---|---|
| MATERIAL | 1_CA | 2_CA | 3_CA |
| CMC | 1.11 | 1.11 | 1.11 |
| Chitosan 1 | 1.11 | 1.11 | 1.11 |
| Citric acid | 11.7 | 11.7 | 11.7 |
| monohydrate | | | |
| Hydrogenated | 32.5 | | 16.25 |
| hydrolysed starch | | | |
| (70%) | | | |
| Xylitol | | 22.75 | 11.375 |
| Tap water | 53.56 | 66.24 | 58.37 |
| Acticide AB6 | 0.09 | 0.09 | 0.09 |
| Sum | 100 | 100 | 100 |

TABLE 4
Lactic acid formulations

| RAW | Binder | Binder | Binder |
|---|---|---|---|
| MATERIAL | 1_LA | 2_LA | 3_LA |
| Chitosan | 1.62 | 1.62 | 1.62 |
| Hydrogenated | 45.5 | | 22.75 |
| hydrolysed | | | |
| starch (70%) | | | |
| Xylitol | | 31.85 | 15.925 |
| Lactic acid | 3.65 | 3.65 | 3.65 |
| (80%) | | | |
| CMC | 0.17 | 0.17 | 0.17 |
| Water | 48.97 | 62.62 | 55.795 |
| Acticide AB6 | 0.09 | 0.09 | 0.09 |
| Sum | 100 | 100 | 100 |

All formulations became transparent or slightly opaque. Films were casted on to polypropylene. The films with xylitol were more flexible than with hydrogenated hydrolysed starch. After freezing, all films become hard. In a fridge (7° C.), the film with only hydrogenated hydrolysed starch became hard, whilst the films with xylitol and xylitol+hydrogenated hydrolysed starch still were soft. This means that the softness of the binder films can be tuned to the right level by choosing the right plasticizer or combination of plasticizers.

Wetlaid nonwoven material were treated according to Method A. Mechanical tests with the treated nonwoven materials were performed according to Method B (dry) and Method C (wet). Results are seen in the Table 5.

TABLE 5
Mechanical properties for wetlaid nonwoven with different formulations

| | | DRY | | | | WET | | | |
|---|---|---|---|---|---|---|---|---|---|
| | | Force | | | | Force | | | |
| | | (kgf/ | | Elongation | | (kgf/ | | Elongation | |
| | gsm | 50 mm) | SD | (%) | SD | 50 mm) | SD | (%) | SD |
| Untreated | 60.8 | 4.2 | 0.1 | 3.5 | 0.55 | — | — | — | — |
| Binder1_CA | 70.9 | 6.9 | 0.4 | 3.3 | 0.34 | 3.8 | 0.2 | 8.4 | 1.3 |
| Binder2_CA | 69.2 | 5.8 | 0.1 | 4.0 | 0.55 | 2.7 | 0.5 | 9.6 | 0.7 |
| Binder3_CA | 69.3 | 6.0 | 0.1 | 3.4 | 0.26 | 2.7 | 0.1 | 11.2 | 0.2 |
| Binder1_LA | 70.8 | 6.2 | 0.3 | 3.9 | 0.21 | 4.0 | 0.3 | 5.4 | 0.5 |
| Binder2_LA | 69.2 | 5.5 | 0.1 | 4.0 | 0.22 | 3.1 | 0.2 | 7.3 | 0.5 |
| Binder3_LA | 70.4 | 5.7 | 0.6 | 3.7 | 0.36 | 3.0 | 0.4 | 5.6 | 1.0 |

Using lactic acid instead of citric acid gave slightly better elongation on the wetlaid nonwoven material. One other finding was that hydrogenated hydrolysed starch as the plasticizer gave an overall better strength.

### Example 2: Development of a Binder Concept with High Strain

The aim of the following test was to increase elongation in the nonwoven material. From the conclusion in Example 1, and to play more with the parameters, it was tested to exclude the anionic part of the PEC. The cationic polymer (chitosan) was kept due to its contribution to wet strength. Two recipes were created, see Table 6.

TABLE 6
Formulations without polyanion

| RAW MATERIAL | Binder 5 | Binder 6 |
|---|---|---|
| Chitosan | 2.1 | 2.1 |
| Hydrogenated | 35 | 10 |
| hydrolysed starch | | |
| (70%) | | |
| Xylitol | | 24.5 |
| Lactic acid (80%) | 1.4 | 1.40 |
| Water | 61.41 | 61.71 |
| Acticide AB6 | 0.09 | 0.09 |
| Dispelair CF56 | | 0.2 |
| Sum | 100 | 100 |

Wetlaid nonwoven material was treated according to Method A. Mechanical tests of the treated nonwoven materials were performed according to Method B (dry). Results are seen in the Table 7.

TABLE 7
Mechanical properties for wetlaid nonwoven with
binder without polyanion

| | | Force | | | |
|---|---|---|---|---|---|
| | | (kgf/ | | Elongation | |
| | gsm | 50 mm) | SD | (%) | SD |
| Untreated | 60.8 | 4.2 | 0.07 | 3.5 | 0.6 |
| Binder 5 | 67.3 | 6.4 | 0.27 | 3.3 | 0.2 |
| Binder 6 | 70.5 | 5.6 | 0.19 | 4.1 | 0.6 |

As can be seen, one of the formulations contributed to higher strain than the other.

### Experiment 3. Comparing Wetlaid and Airlaid Nonwoven Materials

To compare data between wetlaid and airlaid nonwoven, same binders were applied on the two types of nonwoven. A recipe was established where the plasticizer (polyol) could be changed however keeping the same amount (%). The recipe contained both a polyanion and a polycation, hence a PEC. The different polyols used were sorbitol, xylitol and maltitol. See recipe in Table 8.

TABLE 8
Conceptual formulations where
the polyol can be changed

| RAW MATERIAL | Amount (%) |
|---|---|
| CMC | 1.11 |
| Chitosan 1 | 1.11 |
| Citric acid | 11.70 |
| monohydrate | |
| Polyol | 22.75 |
| Tap water | 63.24 |
| Acticide AB6 | 0.09 |
| Sum | 100 |

Wetlaid and airlaid nonwoven were treated according to Method A. Mechanical tests with the treated nonwoven materials were performed according to Method B (dry). Results are seen in the Table 9.

TABLE 9
Mechanical properties for wetlaid and airlaid
nonwoven materials with different plasticizers
used in the PEC based formulation from Table 8.

| | Wetlaid nonwoven | | | | Airlaid nonwoven | | | |
|---|---|---|---|---|---|---|---|---|
| | Force | | Elonga- | | Force | | Elonga- | |
| | (kgf/ | | tion | | (kgf/ | | tion | |
| Plasticizer | 50 mm) | SD | (%) | SD | 50 mm) | SD | (%) | SD |
| Hydrogenated | 6.8 | 0.4 | 3.5 | 0.1 | 3.1 | 0.1 | 4.6 | 0.5 |
| hydrolysed | | | | | | | | |
| starch (70%) | | | | | | | | |
| Sorbitol | 7.2 | 0.4 | 3.0 | 0.2 | 3.2 | 0.1 | 4.6 | 0.2 |
| Maltitol | 7.5 | 0.5 | 2.4 | 0.1 | 3.4 | 0.1 | 3.6 | 0.3 |
| Xylitol | 6.7 | 0.5 | 3.4 | 0.4 | 3.2 | 0.1 | 4.9 | 0.2 |

The results show that elongation is generally higher on airlaid nonwoven than on wetlaid and this is due to the nature of the material. It is also seen that by changing the plasticizer, the elongation changes on both materials. However, strain in the level of 4% is usually not enough on airlaid materials. Hence, a new environmentally friendly binder is needed for airlaid nonwoven materials.

### Experiment 4: Aqueous Binder for Airlaid Nonwoven

Airlaid nonwoven was treated with Binder 5, with the chitosan varied between different grades. Plasticizer was kept the same as in the original recipe. Airlaid nonwovens were treated according to Method A. Mechanical tests with the treated nonwoven materials were performed according to Method B (dry). Results are seen in the Table 10.

TABLE 10
Mechanical properties for airlaid nonwoven
materials treated with variation of Binder 5.

| | gsm | Force | Elongation |
|---|---|---|---|
| | (g/m2) | (kgf/50 mm) | (%) |
| Chitosan 1 | 75.8 | 4.0 | 5.0 |
| Chitosan 2 | 67.1 | 4.2 | 5.6 |
| Chitosan 3 | 84.7 | 5.0 | 6.8 |
| Chitosan 4 | 83.8 | 4.3 | 6.6 |

As can be seen in Table 10, elongations close to 7% can be reached on airlaid nonwoven materials when a binder without polyanion is used. Furthermore, as the binder used in Experiment 4 is biobased, this creates a valid alternative for conventional synthetic binders for airlaid nonwoven materials, that is able to provide both sufficiently good strength and elongation properties. The results also show that strength and elongation properties can be controlled by selecting a chitosan with an appropriate degree of deacetylation.

### Experiment 5: Comparing Elongation for Airlaid Nonwoven

The aim with the experiment was to analyse the difference in elongation between using only a cationic polymer, only an anionic polymer, and a PEC of cationic and anionic polymers.

The different polymers (chitosan and CMC) were homogenized in water, hydrogenated hydrolysed starch, biocide and lactic acid according to the recipe in Table 11. The polymers were present either alone (1.6 wt %) or in combination (0.8 wt % of each).

TABLE 11
Conceptual formulations where
the polymer can be changed

| | Amount (%) |
|---|---|
| Polymer | 1.6 |
| Hydrogenated hydrolysed | 35 |
| starch (70%) | |
| Water | 61.91 |
| Lactic acid | 1.4 |
| Acticide AB6 | 0.09 |
| SUM | 100 |

The binder composition was diluted to 14% and an airlaid nonwoven material consisting of fluff pulp and with one side bonded with EVA (ethylene vinyl acetate) was impregnated using a padder (speed 11.6 rpm, pressure 11.6 MPa). The materials were dried when placed on a conveyer belt and run into an oven set at 160° C. for 30 min. 10 specimens were cut out from the material and tested in a vertical tensile tester. The results are summarized in Table 12.

TABLE 12
Mechanical properties for airlaid nonwoven materials treated
with variation of the binder according to Table 11.

| | | | | Tensile | |
|---|---|---|---|---|---|
| | Grammage | Strain | | index | |
| | (g/m2) | (%) | SD | (Nm/g) | SD |
| Airlaid | 56.4 | 4.5 | | 3.1 | |
| without | | | | | |
| binder | | | | | |
| 1.6% CMC | 66.8 | 4.7 | 0.4 | 8.7 | 0.3 |
| 1.6% | 68.0 | 4.8 | 0.3 | 13.1 | 0.5 |
| Chitosan | | | | | |
| 0.8% CMC + | 65.8 | 3.3 | 0.3 | 9.4 | 0.2 |
| 0.8% | | | | | |
| Chitosan | | | | | |

From the results it can be seen that the elongation is lower for a material treated with a PEC composition in comparison to a material treated with the two different polymers separately. It can also be seen that the tensile index is higher when using chitosan as polymer component without the presence of CMC, or when using CMC alone.

1. An aqueous biobased binder composition for an airlaid nonwoven material, said binder composition comprising an acid, a plasticizer and a cationic polyelectrolyte comprising chitosan, and wherein;
the chitosan has a degree of deacetylation of 66-100%, and wherein the binder composition comprises 0.005-20 wt % of chitosan;
the acid in the aqueous binder composition is a Brønsted acid and/or a Lewis acid, wherein the Brønsted acid is selected from any organic and/or inorganic acids, wherein the Lewis acid is selected from any cationic mono- or multivalent atom, and wherein the aqueous binder composition comprises 0.01-30 wt % of acid;
the aqueous binder composition comprises at least 15 wt % of plasticizer;
the pH of the binder composition is less than 7,
and wherein the cationic polyelectrolyte is not in a complex with an anionic polyelectrolyte.

2. The aqueous binder composition according to claim 1, wherein the composition does not contain an anionic polyelectrolyte.

3. The aqueous binder composition according to claim 1, wherein the composition comprises 0.005-15 wt % of chitosan.

4. The aqueous binder composition according to claim 1, wherein the plasticizer is a polyol selected from one or more of glycerol, mannitol, maltitol, xylitol and sorbitol and saccharides selected from glucose, mannose, fructose, sucrose, sucralose, sucrose esters, cyclodextrin, hydrolysed starch, dextrin.

5. The aqueous binder composition according to claim 1, wherein the acid is selected from one or more of acetic acid, acetylsalicylic acid, adipic acid, benzenesulfonic acid, camphorsulfonic acid, citric acid, dihydroxy fumaric acid, formic acid, glycolic acid, glyoxylic acid, hydrochloric acid, lactic acid, malic acid, malonic acid, maleic acid, mandelic acid, oxalic acid, para-toluenesulfonic acid, phtalic acid, pyruvic acid, salicylic acid, sulfuric acid, tartaric acid and succinic acid.

6. The aqueous binder composition according to claim 1, wherein the composition further comprises at least one or more of an additive selected from defoamer, foaming agent, wetting agent, coalescent agent, catalyst, surfactant, emulsifier, conservative, cross-linker, rheology modifiers, fillers, nonionic polymers, dye and pigment and wherein the concentration of the additive is 0-50% by weight.

7. The aqueous binder composition according to claim 1, wherein the composition comprises at least 22 wt % of plasticizer.

8. The aqueous binder composition according to claim 1, wherein the composition comprises 1-2.5 wt % of chitosan, 20-40 wt % of plasticizer, 0.05-3 wt % of acid and optionally 0.05-10 wt % of at least one or more of an additive selected from defoamer, foaming agent, wetting agent, coalescent agent, catalyst, surfactant, emulsifier, conservative, cross-linker, rheology modifiers, fillers, nonionic polymers, dye and pigment.

9. A method of treating an airlaid nonwoven material with a biobased binder composition, wherein the method comprises the steps of:
a) providing a binder composition comprising an acid, a plasticizer and a cationic polyelectrolyte comprising chitosan, wherein the chitosan has a degree of deacetylation of 66-100%,
the acid in the binder composition is a Brønsted acid and/or a Lewis acid, wherein the Brønsted acid is selected from any organic and/or inorganic acids, wherein the Lewis acid is selected from any cationic mono- or multivalent atom;
b) optionally, diluting the binder composition to an aqueous binder composition according to claim 1
c) applying the composition of step a) or b) to an airlaid nonwoven by applying the binder composition on a formed airlaid nonwoven web;
d) optionally curing the treated airlaid nonwoven material, wherein the curing is performed at 20 to 200 degrees C.

10. The method according to claim 9, wherein the method results in higher elongation of the treated airlaid nonwoven, the method results in an elongation of at least 4%.

11. An airlaid nonwoven material treated with an aqueous binder composition as defined in claim 1.

12. The airlaid nonwoven material according to claim 11, wherein the material exhibits an elongation of at least 4%.

13. Use of an aqueous binder composition according to claim 1 for treating an airlaid nonwoven material.
